(19) United States
(12) Patent Application Publication
(10) Pub. No.: US 2026/0284777 A1
(43) Pub. Date: Sep. 24, 2026

(54) METHOD FOR BONDING

(71) Applicant: Kabushiki Kaisha Toshiba, Kawasaki-shi (JP)

(72) Inventor: Taizo Tomioka, Yokohama Kanagawa (JP)

(21) Appl. No.: 19/450,244

(22) Filed: Jan. 15, 2026

(30) Foreign Application Priority Data
Mar. 21, 2025 (JP) 2025-047546

(51) Int. Cl. B23K 20/12; B23K 20/10

(52) U.S. Cl. CPC B23K 20/125; B23K 20/10

(57) ABSTRACT

According to one embodiment, a bonding method for bonding a first member containing a metal and a second member containing a metal, the method includes a first step of forming a process-affected layer with residual tensile stress in one or both of a surface to be bonded of the first member and a surface to be bonded of the second member, a second step of causing the surface to be bonded of the first member and the surface to be bonded of the second member to face each other, and a third step of bonding the surface to be bonded of the first member and the surface to be bonded of the second member by pressing and heating.

### CROSS-REFERENCE TO RELATED APPLICATIONS

This application is based upon and claims the benefit of priority from Japanese Patent Application No. 2025-047546, filed March 21, 2025, the entire contents of which are incorporated herein by reference.

### FIELD

Embodiments of the present invention relate to a method for joining metal materials.

### BACKGROUND

One of the methods for joining metal materials is thermo-compression bonding. This method is a solid-phase bonding method in which metal materials are heated in a state where the metal materials are pressed against each other and are in close contact with each other, and are bonded to each other without melting the metal materials. The surfaces to be bonded are deformed and brought into close contact with each other by the pressurization of the metal materials, and the metal bonding and the atomic diffusion between the surfaces to be bonded are promoted by heating, thereby joining the metal materials. Therefore, in the thermo-compression bonding, the degree of contact between the surfaces to be bonded and the amount of moisture, organic contaminants, or oxide layer that inhibits metal bonding affect the bonding strength. Therefore, various methods for increasing the bonding strength have been mainly developed by increasing the contact area and/or the adhesion between the surfaces to be bonded and the cleanliness of the surfaces to be bonded. For example, JP2017-104877A1 discloses a method of performing mirror finishing on a surface to be bonded. This method improves the degree of contact between the surfaces to be bonded. For removing the organic contaminants on the surface to be bonded, there is a method of decomposing the organic contaminants by irradiating the surface to be bonded with plasma, for example. As for the oxide layer, for example, when the metal material is Cu, there is a method of oxidation-reduction by heating in a reducing gas containing H₂. In the case of a metal material such as Al which is relatively soft and forms a stable oxide layer on the surface, a method of increasing the surface roughness of the surface to be bonded may be adopted. When the surface roughness increases, the amount of plastic deformation of the surfaces to be bonded at the time of pressurization increases, and the oxide layer is easily broken. As a result, the contact area between the unoxidized metals under the oxide layer increases, and the bonding strength increases. Even when such a method is used, a bonding temperature of about 70% of the melting point in absolute temperature is required for the thermo-compression bonding unless a special bonding environment can be prepared.

On the other hand, in addition to the above-mentioned methods, JP2017-104877A1, JP2002-103055A1, and JPS63-63584A1 disclose methods for achieving bonding by positively utilizing recrystallization of metal. In these methods, strain is applied in advance into the metal material before bonding. The strain energy is used as a driving force to cause recrystallization of the metal on the surfaces where the surfaces to be bonded are in close contact with each other, thereby bonding the surfaces. As a method of applying strain, grinding with emery paper, cold forging, and rolling are disclosed. Therefore, compressive stress remains in the surfaces to be bonded. It has also been shown that in the case of cold forging, the grain size decreases slightly, for example from 1330 μm to 340 μm in Ni-Al alloys. However, it is shown that, even in this joining method, the joining temperature is 700℃ for carbon steel and 900 to 1000℃ for Ni-Al alloy, which is 60 to 70% of the melting point (absolute temperature). The bonding time is long, such as 1 hour for low carbon steel and 10 to 15 minutes for Ni-Al alloy. As described above, in the conventional thermo-compression bonding, it is necessary to press at a high temperature for a long time.

### BRIEF DESCRIPTION OF THE DRAWINGS

FIG. 1 is a schematic diagram illustrating a bonding method according to a first embodiment.

FIG. 2 shows a comparison of the residual stress value in the Al alloy plate and the ultimate tensile load of the joint by five types of process-affected layer forming methods.

FIG. 3 is a set of secondary electron images showing fracture surfaces of joints according to the first embodiment.

FIG. 4 is a schematic process diagram illustrating a bonding method according to a second embodiment.

FIG. 5 is a schematic process diagram illustrating a third step of the bonding method according to the embodiment.

### DETAILED DESCRIPTION

In general, according to an aspect of the invention, there is provided a bonding method for bonding a first member containing a metal and a second member containing a metal. The method includes a first step of forming a process-affected layer with residual tensile stress in one or both of a surface to be bonded of the first member and a surface to be bonded of the second member, a second step of causing the surface to be bonded of the first member and the surface to be bonded of the second member to face each other, and a third step of bonding the surface to be bonded of the first member and the surface to be bonded of the second member by pressing and heating.

Hereinafter, embodiments will be described with reference to the drawings. In the drawings, the same reference numerals are given to the same components, and detailed description thereof will be omitted as appropriate.

### First Embodiment

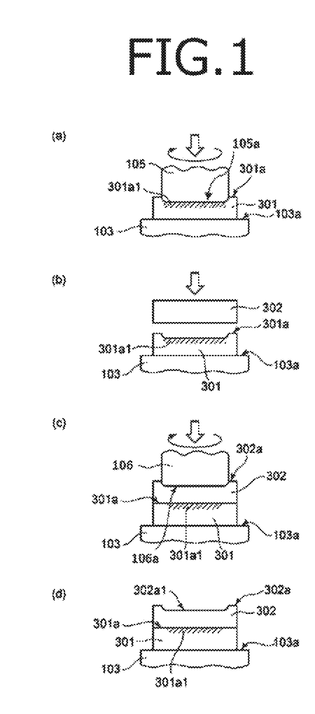

FIGS. 1 is a schematic diagram illustrating a bonding method according to a first embodiment.

The bonding method according to the present embodiment uses any bonding apparatus including a backing plate 103, a processing tool 105, and a bonding tool 106.

As illustrated in FIG. 1(a), the bonding method according to the present embodiment includes a first step of forming a process-affected layer in which tensile stress remains on a surface to be bonded of a first member 301 placed on a backing plate 103, a second step of causing the surfaces to be bonded of the first member 301 and a second member 302 to face each other as illustrated in FIG. 1(b), and a third step of pressing and heating the surfaces to be bonded of the first member 301 and the second member 302 to be in close contact with each other using a bonding tool 106 to bond the surfaces to be bonded as illustrated in FIG. 1(c).

The first member 301 and the second member 302 may be made of the same metal material or different metal materials. The main element of the first member 301 and the second member 302 is preferably mainly composed of a metal exhibiting fine-grained superplasticity. For example, Al, Cu, Fe, Ti, Mg, Ni, or the like can be used. The first member 301 and the second member 302 are, for example, in the form of a plate.

The first member 301 is held on the backing plate 103 by, for example, a fixing chuck or the like. The member mounting surface 103a of the backing plate 103 on which the member is mounted may be a flat surface. The backing plate 103 may be, for example, a metal plate. However, the material of the backing plate 103 is not limited to the example.

The processing tool 105 is a cutting tool equipped with a bottom blade, such as an end mill or a face mill. However, the form of the processing tool 105 is not limited to this, and is not limited to a cutting tool. The processing tool 105 according to the present embodiment may be any tool as long as the processing tool 105 can rub the surface to be bonded of the first member 301 with the tip end by rotation or other operations. For example, the pressing surface at the tip may be a flat surface, a cross-shaped convex portion having a uniform height may be provided at the tip, or a concave portion may be provided in a part of the flat surface. The bonding tool 106 may be, for example, cylindrical in shape and include a pressing surface 106a at an end thereof. In this case, it is more preferable that the pressing surface 106a is a flat surface. By making the pressing surface 106a flat, the pressure to the surface to be bonded can be equalized. The material of the processing tool 105 and the bonding tool 106 may be, for example, tool steel, tungsten alloy, ceramic, diamond, cubic boron nitride, or the like. However, the materials of the processing tool 105 and the bonding tool 106 are not limited to the above.

First, as a first step, as shown in FIG. 1(a), a process-affected layer 301a1 is formed on one surface 301a of a first member 301. The surface 301a and the process-affected layer 301a1 are included in the surface to be bonded of the first member 301. In the surface layer of the process-affected layer 301a1 formed by this step, a residual tensile stress is about 20 to 40 MPa , for example . The process-affected layer 301a1 is often composed of fine crystal grains. For example, in a case where the first member 301 is an Al-Mg alloy containing about 4.5 mass% of Mg, the average grain size of the grains in the surface 301a portion of the first member 301 is, for example, about 30 μm to 100 μm. On the other hand, the average grain size of the grains in the process-affected layer 301a1 can be set to, for example, 1 μm or less.

The process-affected layer 301a1 is formed by machining with a shallow depth of cut using a processing tool 105 equipped with a bottom blade at the axial end face 105a, for example. The machining is a method of pressing the end face 105a of the rotating processing tool 105 against one face 301a of the first member 301 and removing the surface of the face 301a by machining. A recess may be formed on the face 301a of the first member 301 by the machining process. In the process-affected layer 301a1 on the face 301a subjected to the first step, tensile stress mainly remains due to shear deformation caused by the machining process.

When the first member 301 is made of Al-Mg alloy containing about 4.5 mass% of Mg, the rotation speed of the processing tool 105 may be set to about 800 rpm, and the holding time may be set to 3 seconds, for example. The diameter of end face 105a of the processing tool 105 may be, for example, approximately the same as the 10 mm. At this time, the depth of the recess formed in the face 301a by the pressing of the processing tool 105 is, for example, about 0.05 mm. The number of rotations of the processing tool 105 can be changed as appropriate in accordance with, for example, the material of the first member 301. Alternatively, the first step may be performed by dry machining without using a coolant to increase the friction force between the processing tool 105 and the first member 301, thereby increasing the value of the residual tensile stress in the process-affected layer 301a1 and making the grains finer.

In the present embodiment, the machining is exemplified as a method of forming the process-affected layer 301a1. However, the method of causing the residual tensile stress in the process-affected layer 301a1 is not limited to the above. For example, the process-affected layer 301a1 can be formed by rotating tools. For example, the process-affected layer 301a1 may be formed by a friction-stir process instead of machining. When the affected layer 301a1 is formed by the friction-stir process, burrs remain on the outer periphery of the process-affected layer 301a1. The burrs can be removed by machining or the like.

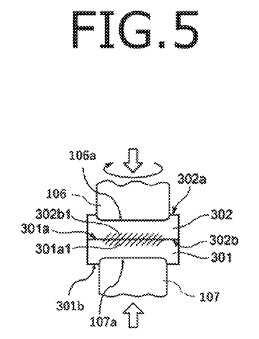

Next, as a second step, as shown in FIG. 1(b), the second member 302 is disposed so as to overlap the face 301a of the first member 301 placed on the backing plate 103. For example, the first member 301 and the second member 302 can be arranged so that the surface to be bonded of the first member 301 and the surface to be bonded of the second member 302 face each other and overlap each other. In FIG. 5, the face 301a is an upper surface of the first member 301, and a face 301b is a lower surface of the first member 301. However, the form of disposing the members is not limited thereto. For example, the second member 302 may be placed on the backing plate 103, and the first member 301 may be placed on the second member 302 so that the face 301a faces the second member 302. The surface to be bonded of the first member 301 according to the present embodiment includes the face 301a and the process-affected layer 301a1. The surface to be bonded of the second member 302 includes the face 302b.

Next, as a third step, as shown in FIG. 1(c), the face 302a of the second member 302 on the side opposite to the first member 301 is pressed by the bonding tool 106 rotated about the axial direction. In FIG. 5, the face 302a is an upper surface of the second member 302, and a surface 302b is a lower surface of the second member 302. With the pressing, the surface to be bonded of the second member 302 and the surface to be bonded including the process-affected layer 301a1 of the first member 301 are pressed by the backing plate 103 and the bonding tool 106 and are brought into close contact with each other. At the same time, the temperature of the second member 302 rises due to frictional heat generated between the bonding tool 106 and the second member 302, and the temperature of the above-described portion in close contact rises. At this time, the number of rotations of the bonding tool 106 can be set to, for example, 600rpm, and the bonding time can be set to, for example, 10 seconds. By pressing the face 302a by the bonding tool 106, a recessed portion 302a1 is formed in the face 302a of the second member 302. The depth of the recess formed in the face 302a can be adjusted to, for example, about 0.3 to 0.4mm.

In the third step, the rotation speed of the bonding tool 106, the depth of pressing into the second member 302, and the bonding time for pressing the second member 302 with the bonding tool may be appropriately changed depending on the strength of the second member 302, the recrystallization temperature, and the like so that the second member 302 and the process-affected layer 301a1 are brought into close contact with each other and the temperature can be raised to the recrystallization temperature or higher. The method of applying pressure and heat to the surfaces to be bonded of the first member 301 and the second member 302 is not limited to the above. In the present embodiment, in the third step, any processing tool, method, or the like may be used as long as the surfaces to be bonded of the first member 301 and the second member 302 can be pressurized from one or both of the first member 301 and the second member 302 and heated to a desired temperature. For example, the processing tool 105 and the bonding tool 106 may be the same tool. Further, instead of the rotating bonding tool 106, it is also possible to use a tool that includes a heater as a heat source and can heat the pressing portion by heat conduction or a tool that applies ultrasonic vibration.

In the third step, the surfaces to be bonded of the first member 301 and the second member 302 are bonded to each other in a solid phase. Burrs formed on the face 302a in the processing step may be removed by machining or the like.

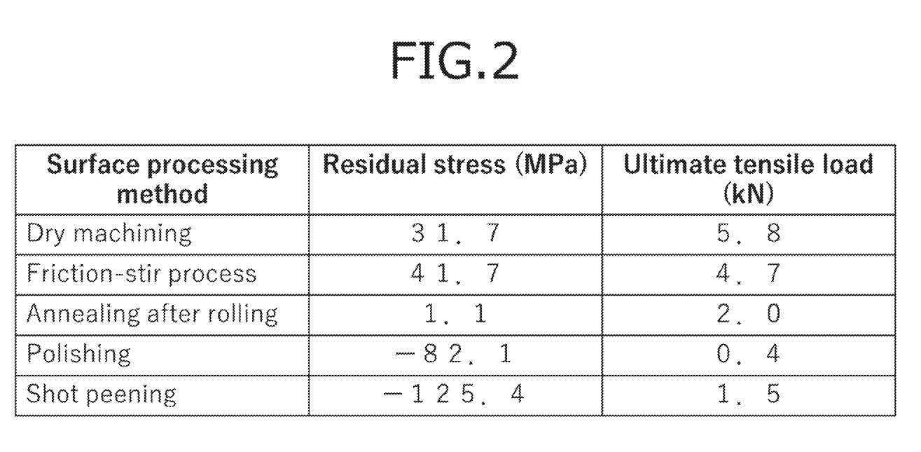

In the bonding methods of JP2017-104877A1, JP2002-103055A1, and JPS63-63584A1, compressive strain is applied into the surfaces to be bonded before bonding. Therefore, compressive stress remains in the surfaces to be bonded. In contrast, in the present embodiment, the tensile stress is caused to remain in the surfaces to be bonded before bonding. In order to clarify the influence of the difference in the direction of the tensile stress on the bonding, different stresses were caused to remain on the surfaces to be bonded by five types of methods, namely, dry machining, a friction-stir process, rolling and annealing, polishing, and shot peening, and after bonding, the breaking loads of the bonded portions was compared using a tensile testing machine. Note that an Al-Mg alloy was used for the first member 301 and the second member 302. FIG. 2 shows the measurement results of residual stress and breaking load. In FIG. 2, a positive value of the residual stress indicates a residual tensile stress. A negative value indicates a residual compressive stress. That is, tensile stress remains in the dry machining and the friction stir process, and compressive stress remains in the polishing and the shot peening. When annealing was performed after rolling, the residual stress value was small. The process-affected layer formed by dry machining, friction stir process, and shot peening is composed of fine crystal grains.

As shown in FIG. 2, the breaking load tends to increase when the tensile stress remains, and the breaking load tends to decrease when the compressive stress remains. That is, in the thermocompression bonding of the metal materials, the method of the present embodiment in which the tensile stress is caused to remain can provide a higher strength of bonding than the method of the related art in which the compressive stress is caused to remain in the surfaces to be bonded. The reason why the value of the residual stress and the breaking load do not have a completely positive correlation is considered to be that there are bonding factors other than the residual stress.

Next, the crystal structure and residual stress in each step were analyzed by electron backscattering diffraction and X-ray diffraction. As a result, it was found that, in the bonding method according to the present embodiment, the fine crystal grains formed in the first step grew across the contact surface between the surfaces to be bonded of the first member 301 and the second member 302 in the third step. That is, the bonding according to the present embodiment is bonding by crystal grain growth, unlike the bonding by recrystallization described so far. Further, since the tensile stress remaining in the surfaces to be bonded is greatly reduced after bonding, it is considered that the possibility of the durability of the bonded portion being reduced by the residual tensile stress is low.

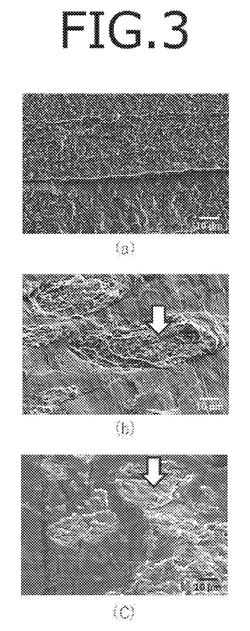

FIG. 3 is a set of secondary electron images showing fracture surfaces of bonding portions between Al-Mg alloy plates according to the present embodiment. As examples, FIG. 3A shows a case where the friction stir process is performed on the surfaces to be bonded, FIG. 3B shows a case where the Al alloy plate is annealed after rolling, and FIG. 3C shows a case where the surfaces to be bonded are polished. When the bonding portion between the Al alloys is fractured by a shear test or the like, a fine uneven shape called a ductile fracture surface is formed in the actually bonding portion. The area where the ductile fracture surface is formed is the true bonding area, and usually, when the area of the ductile fracture surface is large, the ultimate load tends to be high. In the fracture surface of the bonded portion in which the friction stir process shown in FIG. 3A was performed and the residual tensile stress was caused in the bonded surface in advance, a ductile fracture surface was observed on almost the entire surface of the secondary electron image. On the other hand, in FIG. 3B in which the residual stress of the surface to be bonded is small and FIG. 3C in which the compressive residual stress is caused, the ductile fracture surface indicated by the arrow is partial. That is, when the tensile stress remains in the surface to be bonded, the true bonding area becomes large. On the contrary, when the compressive stress remains in the surface to be bonded, the true bonding area tends to be small.

In the first step of the present embodiment, a process-affected layer 301a1 which is constituted by fine crystal grains and in which mainly residual tensile stress remains is formed on the surface to be bonded. Here, the fine crystal grains refer to crystal grains refined to an average diameter of 1 μm or less, for example, in the present embodiment. As a mechanism of crystal refinement, for example, it is considered that lattice defects introduced into crystal grains by plastic deformation due to machining in the first step are accumulated to form nuclei, and new fine crystal grains are generated. In addition, as the crystal grains of the metal material become smaller, the number of crystal grain boundaries, which are boundaries between adjacent crystal grains, increases. As the crystal grains become smaller, the movement of lattice defects contributing to deformation is hindered by the crystal grain boundaries, and therefore the strength of the material increases. This phenomenon is known as the Hall-Petch effect. On the other hand, it is known that, when crystals are refined in a metal such as an Al alloy, the metal exhibits higher ductility than usual at a certain temperature and develops fine-grained superplasticity extending to several hundred percents or more. It is considered that the fine-grained superplasticity is exhibited because the contribution ratio of the crystal grain boundary sliding to the deformation is high. In a state when superplasticity is occurred, the deformation resistance decreases. The reduction in deformation resistance contributes to improvement in the degree of contact area and/or adhesion of the surfaces to be bonded, and is considered to be one of the bonding factors in the present embodiment. Examples of the material exhibiting the fine-grained superplasticity include Ti alloy, Cu alloy, and Fe alloy, in addition to Al alloy.

The mechanism by which the tensile stress mainly remains in the process-affected layer 301a1 is considered to be that the first member 301 is rubbed by the processing tool 105 and tensile deformation occurs on the surfaces of the first member 301. It is known that the residual stress of a metal material affects the hardness. When the compressive stress remains, the hardness of the surface becomes high, and when the tensile stress remains, the hardness becomes low. Therefore, the fact that deformation of the minute irregularities on the surface was likely to occur due to the residual tensile stress is also considered to be one of the reasons that increased the load of the bonded portion when the surfaces to be bonded were processed by the dry machining and friction stirring processes.

The first step according to the present embodiment is different from a conventional treatment of a surface to be bonded for the purpose of, for example, cleaning the surface to be bonded. In addition, in the related art, regarding the application of strain into the surface to be bonded, residual compressive stress is applied. However, from the results of the bonding experiments shown in FIGS. 2 and 3, it was found that when the processing of forming the affected layer in which the residual tensile stress mainly remains is performed on the surface to be bonded of the first member 301 in the first step, the ultimate tensile load of the bonding portion increases. That is, the present inventors have found that, in metal bonding, when thermo-compression bonding is performed after a residual tensile stress is actively caused to remain in a surface to be bonded, the strength of the bonded portion is higher than that in a case when thermo-compression bonding is performed after a residual compressive stress is caused to remain in a surface to be bonded. The reason for this is considered to be that the formation of the process-affected layer with the residual tensile stress increases the degree of contact area and/or adhesion between the surfaces to be bonded and promotes the growth of crystal grains during heating. In the present embodiment, good bonding was obtained with an ultimate tensile load of 4.7 kN and 5.8 kN by short-time bonding of 10 seconds. This ultimate tensile load is almost equivalent to the breaking load of resistance spot weld described in the Japanese Industrial Standard Z3140 (2017), and is practical.

### Second Embodiment

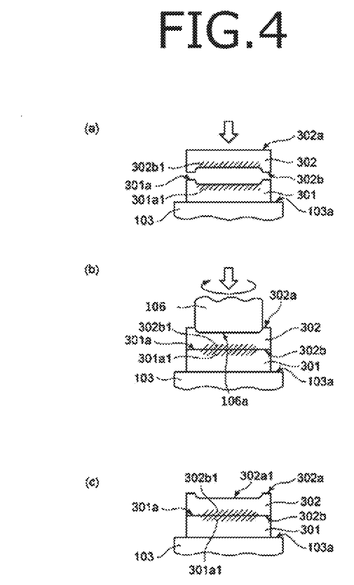

A second embodiment will be described with reference to FIG. 4. The same points as those in the first embodiment will not be described. FIGS. 4A to 4C are schematic process diagrams for illustrating the bonding method according to the embodiment. The bonding method according to the present embodiment can use any bonding apparatus shown in the first embodiment.

The bonding method according to the present embodiment includes a first step of forming a process-affected layer 301a1 and a process-affected layer 302b1 with the residual tensile stress in a surface 301a of a first member 301 and a surface 302b of a second member 302, respectively, a second step of causing the surfaces to be bonded of the first member 301 having the process-affected layer 301a1 formed on a backing plate 103 and the second member 302 having the process-affected layer 302b1 formed thereon to face each other as illustrated in FIG. 4(a), and a third step of pressing and heating the surfaces to be bonded of the first member 301 and the second member 302 so as to be in close contact with each other using a bonding tool 106 and bonding the surfaces as illustrated in FIG. 4(b).

The materials of the first member 301 and the second member 302 according to the present embodiment are the same as those of the first embodiment. In the first embodiment, a method of forming the process-affected layer 301a1 only on the surface 301a of the first member 301 and bonding the first member 301 to the second member 302 has been described, but in the present embodiment, the process-affected layer is formed on both the first member 301 and the second member 302.

The processing tool 105 according to the second embodiment is a processing tool for a friction-stir process having, for example, a cylindrical shape. A protruding stirring pin is provided on an end face of a processing tool for performing general friction stir bonding. However, the end face 105a of the processing tool 105 according to the present embodiment is a flat face, and no stirring pin is provided. The processing tool 105 according to the present embodiment may have any structure as long as the surface to be bonded of the first member 301 can be rubbed with the tip end, and for example, a spiral groove, a protrusion, or the like may be provided in the end face 105a of the processing tool 105. The end face 105aof the processing tool 105 is more preferably a flat face as shown in FIG. 1(a), for example. The material of the processing tool 105 may be, for example, tool steel, tungsten alloy, ceramic, diamond, cubic boron nitride, or the like. However, the material of the processing tool 105 is not limited to this.

First, as a first step, as illustrated in FIG. 1(a) of the first embodiment, a process-affected layer 301a1 with residual tensile stress is formed on one surface 301a of a first member 301 placed on a backing plate 103. Similarly, a process-affected layer 302b1 with residual tensile stress remains is formed on one surface 302b of the second member 302 placed on the backing plate 103. Note that the order of forming the process-affected layer on the first member 301 and the second member 302 is not limited. The process-affected layer 301a1 and the process-affected layer 302b1 formed in each member by the first step according to the present embodiment are often constituted by fine crystal grains having residual tensile stress.

By forming the process-affected layer 301a1 and the process-affected layer 302b1 according to the present embodiment, a recess may be formed in each of the surface 301a and the surface 302b. Note that the processing method for forming the process-affected layer on the surface 301a and the surface 302b is not limited to the above. For example, the processing methods for forming the process-affected layers on the surface 301a and the surface 302b may be different.

Next, as a second step, as shown in FIG. 4(a), the second member 302 is disposed on the surface 301a of the first member 301 placed on the backing plate 103 so that the respective surfaces to be bonded face each other. In FIG. 4(a), the surface 301a is an upper surface of the first member 301, and the surface 301b is a lower surface of the first member 301. In FIG. 4(a), the surface 302a is an upper surface of the second member 302, and the surface 302b is a lower surface of the second member 302. However, the form of disposing the members is not limited thereto. For example, the second member 302 may be placed on the backing plate 103, and the first member 301 may be disposed thereon. In the present embodiment, the surface to be bonded of the first member 301 includes the surface 301a and the process-affected layer 301a1. The surface to be bonded of the second member 302 includes the surface 302b and the process-affected layer 302b1.

Next, as a third step, as illustrated in FIG. 4(b), the surface 302a of the second member 302 on the side opposite to the first member 301 side is pressurized by the rotating bonding tool 106, and the surface to be bonded of the first member 301 and the surface to be bonded of the second member 302 are brought into close contact with each other. At the same time, the temperature of the second member 302 rises due to frictional heat generated between the bonding tool 106 and the second member 302, and the temperature of the portion where the surface 301a and the surface 302b are in close contact with each other rises. By the pressing of the bonding tool 106, a recess may be formed in the surface 302a of the second member 302 as illustrated in FIG. 4(c).

In the third step according to the present embodiment, any method may be used as long as the surface 301aof the first member 301 and the surface 302b of the second member 302 can be brought into close contact with each other and a predetermined amount of heat can be applied. For example, the processing tool 105 may be used instead of the bonding tool 106. For example, a tool including a heater or an ultrasonic application tool may be used instead of the rotating bonding tool 106.

For example, in the third step according to the present embodiment, a second bonding tool 107 may be used instead of the backing plate 103 as shown in FIG. 5. The second bonding tool 107 may have, for example, a cylindrical shape similar to that of the bonding tool 106. In this case, it is more preferable that the pressing surface 107a of the second bonding tool 107 is a flat surface. By making the pressing surface 107aflat, the pressure to the surface to be bonded can be equalized. The material of the second bonding tool 107 may be, for example, tool steel, tungsten alloy, ceramic, diamond, cubic boron nitride, or the like. The materials and shapes of the bonding tool 106 and the second bonding tool 107 may be different from each other. The form of the second bonding tool 107 is not limited to the above.

In the case of using the second bonding tool 107, as shown in FIG. 5, in the third step, the surface 302a of the second member 302 on the side opposite to the first member 301 side is pressurized by the rotating bonding tool 106. Similarly, the surface 301b of the first member 301 on the side opposite to the second member 302 side is pressurized by the rotating second bonding tool 107. Accordingly, the surface to be bonded of the first member 301 and the surface to be bonded of the second member 302, which are overlapped in the second step, are brought into close contact with each other. At the same time, the temperature of the contact surface between the surface 301a and the surface 302b rises due to frictional heat generated between the bonding tool 106 and the second member 302. By the pressing of the bonding tool 106, a recess may be formed in each of the surface 302a of the second member 302 and the surface 301b of the first member 301.

In the third step, by rotating the second bonding tool 107, frictional heat can be generated also between the second bonding tool 107 and the first member 301. If the second bonding tool 107 is rotated, it is preferred that the bonding tool 106 is not rotated or is rotated in a different direction than the bonding tool 106. The second bonding tool 107 may be a tool that includes a heater as a heat source and can heat the pressing portion by heat conduction, an ultrasonic application tool, or the like. The rotation speed, the pressing load, the pressing time, and the like of the bonding tool 106 and the second bonding tool 107 may be appropriately changed depending on the strength and the melting point of the material. The method of pressing the surface 301a of the first member 301 and the surface 302b of the second member 302 to bring them into close contact with each other and heating them is not limited to the described above.

The first member 301 and the second member 302 are partially bonded to each other by the third step.

The present invention is not limited to the above-described embodiment, and various modifications can be made without departing from the scope of the present invention. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

What is claimed is:

1. A method for bonding a first member containing a metal and a second member containing a metal, the method comprising:
a first step of forming a process-affected layer with residual tensile stress remains on one or both of a surface to be bonded of the first member and a surface to be bonded of the second member,
a second step of causing a surface to be bonded of the first member and a surface to be bonded of the second member to face each other, and
a third step of bonding the surface to be bonded of the first member and the surface to be bonded of the second member by pressing and heating.

2. The bonding method according to claim 1, wherein
in the first step, the process-affected layer is formed by a rotating tool.

3. The bonding method according to claim 1, wherein
the process-affected layer is formed by machining in the first step.

4. The bonding method according to claim 1, wherein
in the first step, the process-affected layer is formed by a friction-stir process.

5. The method according to claim 1, wherein
the member on which the process-affected layer is formed mainly contains a metal that exhibits fine-grained superplasticity.

6. The bonding method according to claim 1, wherein
the member on which the process-affected layer is formed contains any one of Al, Cu, Fe, Ti, Mg, and Ni as a main element.

7. The bonding method according to claim 1, wherein
the third step includes heating by a method including any one of frictional heat by a rotating tool, heat by a heater, and frictional heat by application of ultrasonic vibration.
